(19) United States
(12) Patent Application Publication
(10) Pub. No.: US 2009/0101029 A1
(43) Pub. Date: Apr. 23, 2009

(54) METHOD AND DEVICE TO PREPARE FLEXOPRINTING FORMS

(76) Inventors: Malte Juergensen, Rickert (DE); Rainer Wilhelm Schenk, Klausdorf (DE)

Correspondence Address: SCHIFF HARDIN, LLP;PATENT DEPARTMENT, 6600 SEARS TOWER, CHICAGO, IL, 60606-6473, US

(21) Appl. No.: 12/247,481

(22) Filed: Oct. 8, 2008

(30) Foreign Application Priority Data
Oct. 18, 2007 (DE) 10 2007 050 339.5

(51) Int. Cl. B41F 5/00

(52) U.S. Cl. 101/216

(57) ABSTRACT

In a system to support a flexoprinting cylinder to permit placement thereon or removal therefrom of a flexoprinting sleeve or a spacer for the flexoprinting sleeve, and which permits rotation of the cylinder for processing of the flexoprinting form, an engagement device is provided with which the flexoprinting cylinder is automatically engaged for driving in a rotating manner for the processing of the flexoprinting form mounted on the flexoprinting cylinder. The engagement device comprises respective cones inserted into respective end openings located in the respective pins at opposing ends of the flexoprinting cylinder, and for at least one of the cones, a support device supports the respective pin at one end of the flexoprinting cylinder during an insertion or retraction of the respective cone. The support device also has a stop engageable behind a recess in the pin.

### BACKGROUND

The preferred embodiment concerns a method to prepare illustrated and/or unillustrated flexoprinting forms, in particular flexoprinting cylinders and/or flexoprinting sleeves.

Furthermore, the preferred embodiment concerns a device to prepare illustrated and/or unillustrated flexoprinting forms, in particular flexoprinting cylinders and/or flexoprinting sleeves.

A device for direct laser engraving of printing forms (in particular flexoprinting forms as well, advantageously flexoprinting cylinders) with which flexoprinting forms can thus be illustrated is disclosed in WO 00/13839.

A cylinder core (what is known as a mandrel) is frequently reused in flexoprinting cylinders while the actual flexoprinting form as a flexoprinting sleeve is axially drawn onto the mandrel, illustrated, used in a printing machine, and subsequently pulled off again and then either disposed of or stored for a later reuse. Since the flexoprinting forms for different printing formats can have different circumferences and correspondingly different inner diameters, if possible not too many different mandrels should be used. Therefore spacer sleeves (what are known as spacers) are frequently placed between the mandrel and the flexoprinting sleeve. The putting on and taking off of the flexoprinting sleeves and/or spacers occurs manually for the most part in special assembly devices. For example, such an assembly device has been disclosed in EP 0787 597.

### SUMMARY

It is an object to provide ways to increase the productivity in the aforementioned technical categories.

In a system to support a flexoprinting cylinder to permit placement thereon or removal therefrom of a flexoprinting sleeve or a spacer for the flexoprinting sleeve, and which permits rotation of the cylinder for processing of the flexoprinting form, an engagement device is provided with which the flexoprinting cylinder is automatically engaged for driving in a rotating manner for the processing of the flexoprinting form mounted on the flexoprinting cylinder. The engagement device comprises respective cones inserted into respective end openings located in the respective pins at opposing ends of the flexoprinting cylinder, and for at least one of the cones, a support device supports the respective pin at one end of the flexoprinting cylinder during an insertion or retraction of the respective cone. The support device also has a stop engageable behind a recess in the pin.

### BRIEF DESCRIPTION OF THE DRAWINGS

FIG. 1 is a schematic, perspective view overview of an exemplary embodiment of a work line;

FIG. 2 is a side view of an engagement device for a flexoprinting cylinder at one end of the flexoprinting cylinder;

FIG. 3 is an assembly station according to the preferred embodiment for sleeves, in a schematic, perspective view;

FIG. 4 is a locking device to lock one end of a flexoprinting cylinder in the assembly station according to FIG. 3; and

FIG. 5 is a locking block of the locking device according to FIG. 4 in a perspective view.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention related are included.

With regard to the method, an illustration device for illustration of a flexoprinting form is automatically loaded with flexoprinting forms to be illustrated.

In principle, a device in the manner of the device known from WO 00/13839 can be used as an illustration device. According to the preferred embodiment, this is automatically loaded with flexoprinting forms with a corresponding loading device in order to increase its throughput (and therefore its productivity). Independent of this, the number of engraving tools can naturally also be increased to raise the productivity, and/or multiple illustration devices could be used and loaded.

So that a flexoprinting cylinder delivered to the illustration device can also be automatically detected and processed, according to one development of the preferred embodiment it is provided that a flexoprinting cylinder is automatically engaged so that it can be driven in a rotating manner, for which it could preferably be provided according to the preferred embodiment that a flexoprinting cylinder is engaged by means of cones that can be inserted into end openings of the flexoprinting cylinder. This flexoprinting cylinder can be a flexoprinting cylinder as is also later used in a printing machine; however, it can also be a special cylinder for an engraving with which the sleeves to be illustrated are provided, such that the illustrated sleeve is later mounted on another cylinder provided for the printing.

A placement in the illustration device from above by means of a crane is preferably facilitated according to the preferred embodiment in that a pin of a flexoprinting cylinder, at least in one of the cone regions, is supported in an entrance or exit of the cone, which could be realized with a tablet-like (advantageously basin-shaped) tray, for example.

Another development of the preferred embodiment provides that the rotational position of a flexoprinting cylinder is detected by a groove detection.

According to the preferred embodiment, it can additionally be provided that a flexoprinting sleeve assembly station is provided at which sleeves can be pulled onto and off of a mandrel, wherein the mandrel is advantageously engaged on one side in the flexoprinting sleeve assembly station.

A next development of the preferred embodiment provides that a finished, illustrated flexoprinting form is washed with the aid of an automatic, loadable washer.

Furthermore, according to the preferred embodiment, unillustrated and/or partially illustrated and/or illustrated flexoprinting forms (in particular flexoprinting cylinders) can be stored in a storage, advantageously flexoprinting sleeves and/or spacer sleeves (spacers) and/or mandrels as well.

A further development of the method according to the preferred embodiment is characterized in that at least some workstations are arranged on a work production line. In particular, some workstations can thereby preferably be connected with one another via a crane travel.

Another development of the preferred embodiment is that a workflow (in particular across different workstations) is controlled by means of a job ticket created and processed in an electronic data processing device. For this, a job ticket station can also be connected with a line controller for workstations arranged in a line and/or with an RIP station (raster image processor). In particular, a job ticket can also contain all data that are input into the RIP configuration in the manual operation as well as at control terminals of the engraving machine and the washer. Status information can also be written that enable a “job tracking” and also a “job scheduling”.

An independent protection is also claimed for a device to automatically prepare illustrated and/or unillustrated flexoprinting forms (in particular flexoprinting cylinders and/or flexoprinting sleeves) that, in an independent solution of the posed object according to the preferred embodiment, is characterized by an illustration device that can automatically be loaded with a flexoprinting form.

The device according to the preferred embodiment is advantageously characterized by an engagement device with which flexoprinting cylinders can be automatically engaged so that they can be driven in a rotating manner, wherein the engagement device preferably possesses cones that can be inserted into openings at the ends of a flexoprinting cylinder.

A loading of the device according to the preferred embodiment from above with a crane is advantageously facilitated in that, for at least one of the cone regions, a support device supporting a pin of a flexoprinting cylinder during an entrance or exit of the cone is provided, preferably protruding in the manner of a tray beyond the associated cone. In particular, the support device can possess an acceptance basin for insertion of the pin. This placement possibility according to the preferred embodiment also secures the flexoprinting cylinder before the flexoprinting cylinder is engaged and after it is released again, advantageously with precise positioning for mounting and dismounting of the cones, in particular even when the cones enter into the respective ends of the flexoprinting cylinder at different points in time.

A next development provides that the support device possesses a claw-like stop to engage behind a recess in the pin. This has the advantage that, with the aid of the rear engagement, the flexoprinting cylinder can also be forcibly released from the cones if necessary, even if a cone is firmly seated in an insertion hole, for example. The claws then hold tight asymmetrically (due to the exit movement) in the region of the already-detached cone of the cylinder and produces a sufficient resistance at the other cone via which the other cone then also finally releases from the flexoprinting cylinder. The same recess in the respective pins of the flexoprinting cylinder can also advantageously be used to retain and lock the flexoprinting cylinder in the flexoprinting sleeve assembly station cited in the preceding.

In addition, the support device can possesses at least one bearing roller with a roller axis oriented parallel to the pin axis in order to center the pins and/or hold them in the manner of a lunette.

The device according to the preferred embodiment can possesses a groove detection device to detect the rotational position of a flexoprinting cylinder, as is known in principle for rotogravure cylinders in possibly comparable art from DE 101 07 192.

As aforementioned, the device according to the preferred embodiment can have a flexoprinting sleeve assembly station at which sleeves can be placed on and taken off a mandrel or what is known as an air cylinder, wherein these could comprise an engagement device for the one-sided engagement of a pin of a mandrel and/or of a flexoprinting cylinder or air cylinder. In particular, the engagement device could possesses a type of coupling bushing with which the pin could be locked without force, and in fact preferably also possibly under engagement with the recess of the pin mentioned in the preceding.

The designation “air cylinder” used in part should indicate that compressed air is used to put on or take off a spacer or a sleeve, which compressed air flows out radially from and/or axially relative to the air cylinder, for example, in order to generate air cushions on which the corresponding sleeve can slide better, via which it can also in particular be expanded, however. According to the preferred embodiment, it could in particular also be provided in the assembly station to redirect such air (for example with the aid of a type of cover) so that it can selectively be used for a spacer or a sleeve.

A development of the device of the preferred embodiment provides that a carrier device for a flexoprinting cylinder is pivotable around a vertical axis so that the flexoprinting cylinder is accessible for a more comfortable assembly, in particular when the assembly station is integrated into an illustration device itself (which is by all means possible).

The device according to the preferred embodiment and/or a work line can possesses a washer that can be automatically loaded with a finished, illustrated flexoprinting form, which washer is advantageously equipped with a cover that opens and closes automatically, in particular closes so as to be liquid-tight. Material residues after the illustration, in particular after a direct ablative laser engraving, can automatically be washed off there in order to assemble the illustrated flexoprinting form and to provide it ready for printing.

Furthermore, a support for unillustrated and/or partially-illustrated and/or illustrated flexoprinting forms (in particular flexoprinting cylinders) can advantageously be provided that, for example, is fashioned as a flat rack, and a support for flexoprinting sleeves and/or spacer sleeves (spacers) and/or mandrels can be provided that is fashioned as an adjustable support, for example.

As already explained in the preceding, the concept according to the preferred embodiment can be characterized in that at least some workstations are arranged on a work line, whereby the supports can be entirely or partially incorporated. In particular, some workstations could be connected with one another via a crane work path (which crane is fashioned as a traveling crane, for example). However, most of all it could preferably be provided that the workstations and work steps are controlled logistically and in their workflow (also with regard to an execution time plan, for example) by means of a job ticket generated and processed in an electronic data processing device, in particular by a control device to control a workflow, in particular via different workstations. For this the control device can preferably also be connected or coupled with a linear controller for workstations arranged in a line and/or with a RIP station (raster image processor).

Exemplary embodiments regarding the present preferred embodiment from which additional features can also arise (to which features the invention is, however, not limited in its scope) are presented in the drawings.

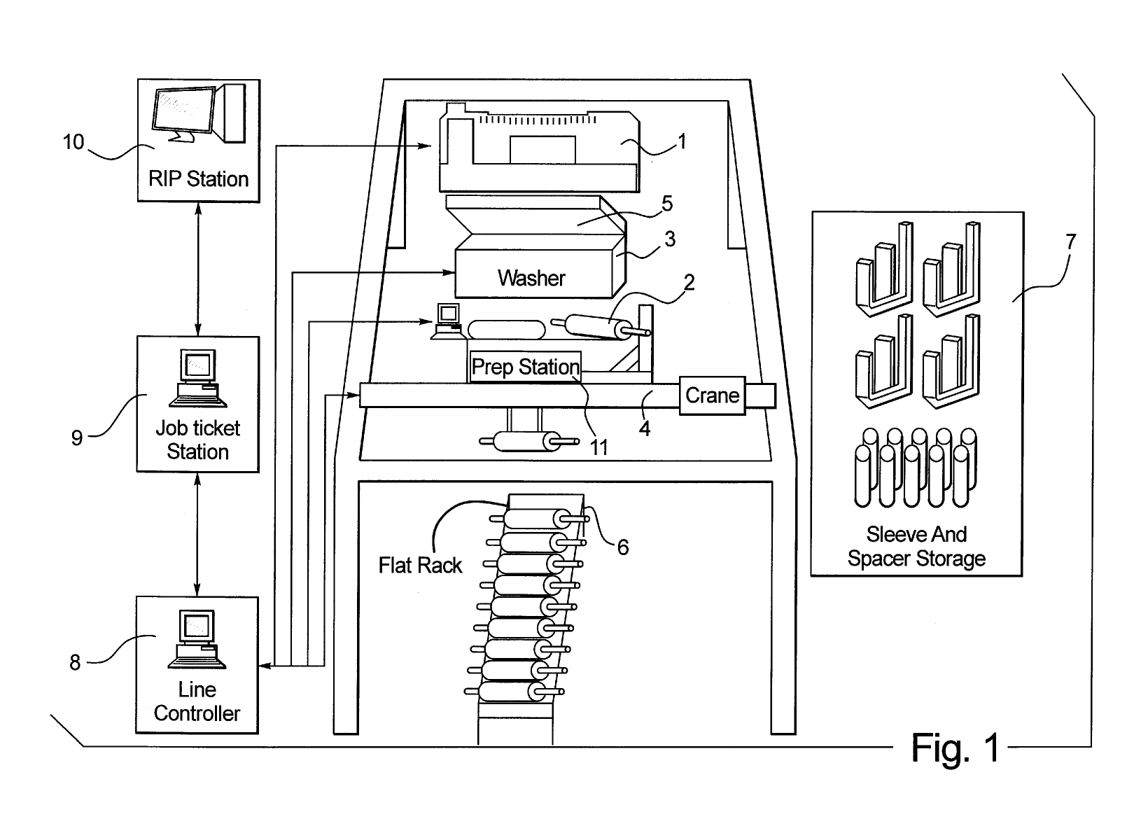

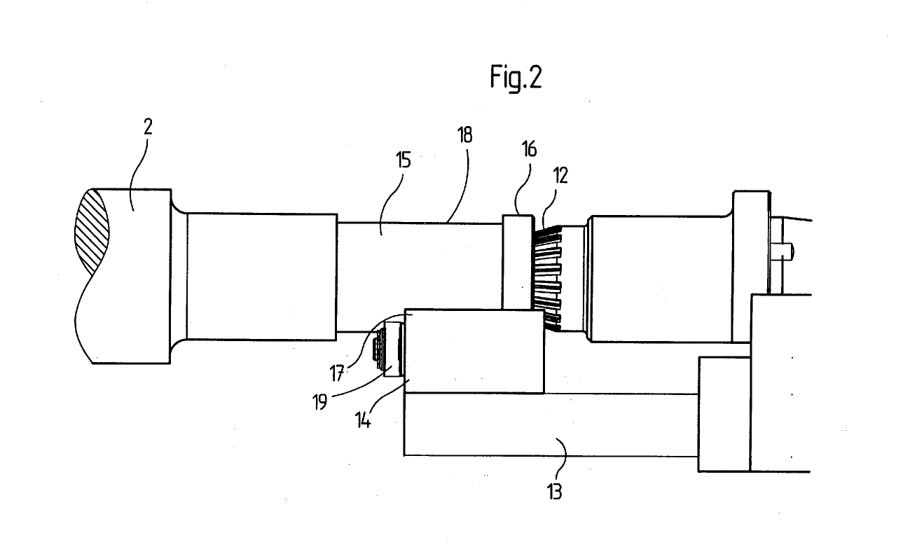

As shown in FIG. 1, a washer 3 is associated with an engraving machine 1 for flexoprinting cylinders 2, in which washer 3 a finished, engraved flexoprinting cylinder 2 can be washed in order to be ready for printing. Both the engraving machine 1 and the washer 3 can be automatically supplied with an flexoprinting cylinder. For this a crane 4 is in particular provided that can travel over a large portion of the work line. The washer is additionally provided with a cover 5 that automatically opens and closes. A flexoprinting cylinder 2 can be automatically engaged and released in the engraving machine 1, which is explained in detail with FIG. 2.

In particular, a flat storage rack 6 for completely engraved or half-finished flexoprinting cylinders with or without sleeves and an adjustable storage rack 7 for sleeves and spacer sleeves (spacers) are provided in the region of the work line shown in FIG. 1.

A line controller 8, a job ticket station 9 and a RIP station 10 that operate per electronic data processing are additionally associated with the work line.

Moreover, an assembly station 11 in which a sleeve can be pulled onto a flexoprinting cylinder 2 or pulled off of this is placed in approximately the center of the work line, between the engraving machine 1 and the stores 6, 7.

FIG. 2 shows a side view of an engagement device of an engraving machine 1 for one end of a flexoprinting cylinder 2. The engagement device comprises an engagement cone 12 that enters into an open end of the flexoprinting cylinder 2 in order to hold and clamp this.

A basin-shaped tray 14 for a pin 15 of the flexoprinting cylinder 2 is arranged protruding on a crane arm 13 below the cone 12. The pin 15 securely lies on this tray 14 even when the cone 12 has not yet entered into the tray 14 in order to hold it, or when the pin 15 has already been released from the cone 12 again to extract the flexoprinting cylinder 2. The pin 15 can in particular be securely and simply placed on the tray 14 or be raised from this with the crane 4. The other end of the flexoprinting cylinder 2 is similarly clamped in a mirror-symmetrical manner.

In particular, upon release of the flexoprinting cylinder 2 and the exit of the respective cone 12, it can occur that the cone 12 sits too tightly in the pin 15 and cannot immediately come free. If this occurs at one end of the flexoprinting cylinder 2 and not at the other end, the one cone 12 releases but the other cone 12 does not, such that the not-yet-released cone goes along and shifts in the axial direction in its further insertion into the flexoprinting cylinder. The pin 15 at the other end of the flexoprinting cylinder 2 thereby shifts in the tray 14 there. This occurs until a collar 16 of the pin 15 hits a stop (not shown in detail) of the tray 14 that protrudes at the free end 17 of the tray 14 and engages in a recess 18 of the pin 15 (which recess 18 is limited by the collar 16). The length of the recess 18 thus offers play for the release of the cone 12 at the other end.

Bearing rollers 19 for the pin 15 are additionally arranged at the free end 17 of the tray 14.

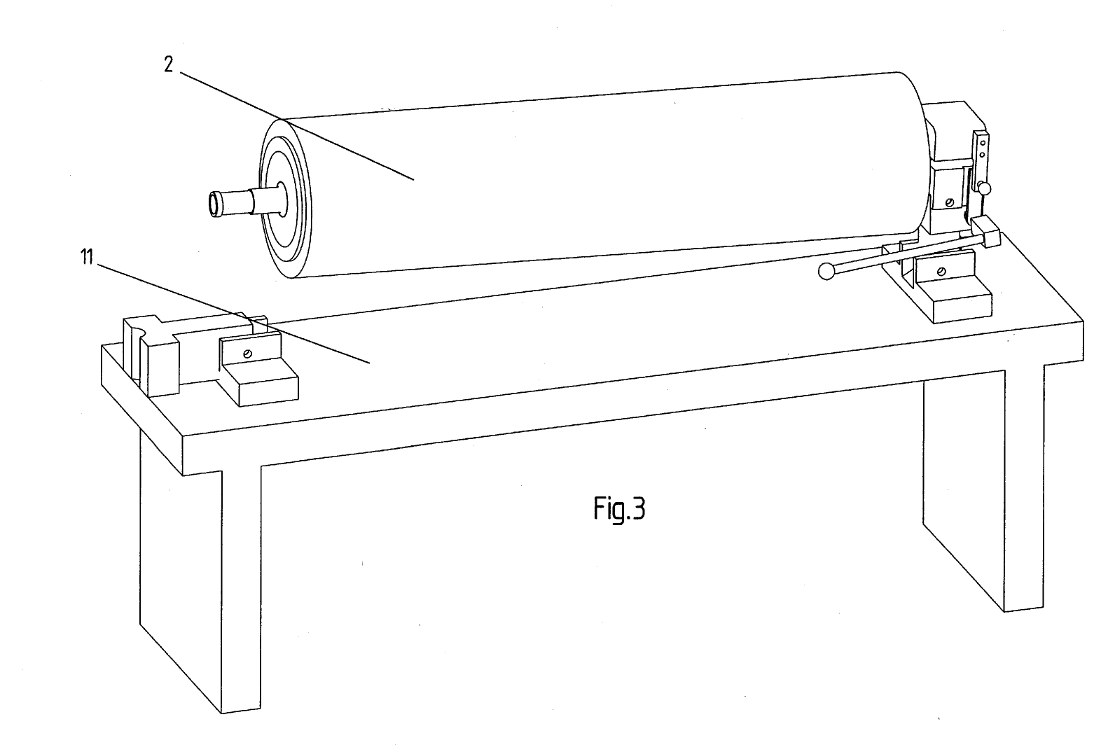

FIG. 3 shows an assembly station 11 in a schematic, perspective view. It is thereby important that one end of the flexoprinting cylinder 2 can be free while the flexoprinting cylinder is held securely at the other end. A spacer and/or a sleeve can then be placed on or taken off a mandrel of a flexoprinting cylinder 2 via the free end, wherein the expansion of the sleeves and their axial slide can be supported by compressed air feed.

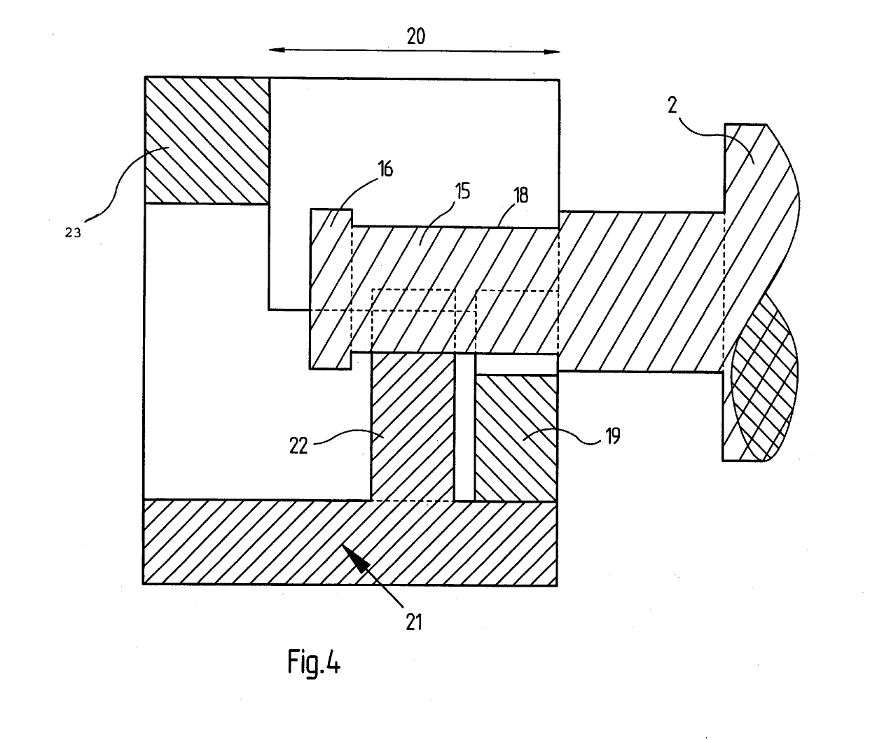

FIG. 4 shows in section a locking device for an assembly station 11 in which a pin 15 of a flexoprinting cylinder 2 can be securely locked. To lock and unlock, a locking block 23 can be inserted and retracted in the direction of a double arrow 20 that runs parallel to the axis of the flexoprinting cylinder 2. This displacement 20 occurs on a fixed base 21 on which the crane 4 can initially place the pin 15. A stop 22 of the base 21 thereby engages in the recess 18 of the pin 15 and limits its axial movement play. If the locking block 23 is displaced into its locking position (to the right in the drawing), it overlaps the pin 15. If the other end of the flexoprinting cylinder 2 now comes free, the locked pins 15 can't due to the inherent weight of the flexoprinting cylinder 2 itself, and the flexoprinting cylinder 2 is securely held at one end.

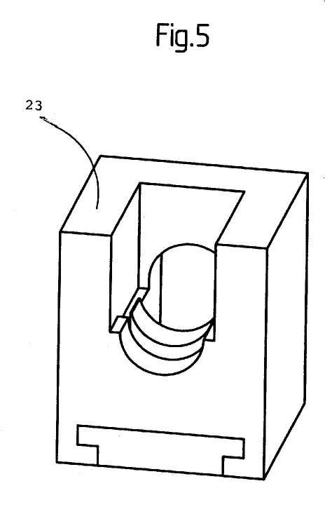

FIG. 5 shows the locking block 23 according to FIG. 4 in a perspective view.

While preferred embodiments have been illustrated and described in detail in the drawings and foregoing description, the same are to be considered as illustrative and not restrictive in character, it being understood that only two preferred embodiments have been shown and described and that all changes and modifications that come within the spirit of the invention both now or in the future are desired to be protected.

We claim as our invention:

1. A system to support a flexoprinting cylinder to permit placement thereon or removal therefrom of a flexoprinting sleeve or a spacer for the flexoprinting sleeve, and which permits rotation of said cylinder for processing of said flexoprinting form, comprising:
an engagement device with which the flexoprinting cylinder is automatically engaged for driving in a rotating manner for the processing of the flexoprinting form mounted on the flexoprinting cylinder;
the engagement device comprising respective cones inserted into respective end openings located in respective pins at opposing ends of the flexoprinting cylinder, and for at least one of the cones, a support device supporting the respective pin at one end of the flexoprinting cylinder during an insertion or retraction of the respective cone; and
the support device having a stop engageable behind a recess in the pin.

2. A system according to claim 1 wherein the support device protrudes like a tray beyond the respective cone.

3. A system according to claim 1 wherein the support device has an acceptance basin for insertion of the pin.

4. A system according to claim 1 wherein the support device has at least one bearing roller with a roller axis parallel to an axis of the pin.

5. A system according to claim 1 wherein said flexoprinting sleeve comprises a hollow cylinder and said spacer comprises a hollow cylinder which are slipped over an end of said flexoprinting cylinder when said flexoprinting cylinder is supported by said support device at said one end of the flexoprinting cylinder.

6. A system according to claim 1 wherein a sleeve and spacer storage is located near said engagement device from which sleeves or spacers are retrieved for placement over and around said flexoprinting cylinder.

7. A system according to claim 6 wherein a storage is also provided for said flexoprinting cylinders near said engagement device.

8. A system according to claim 1 wherein the engagement device further comprises a coupling bushing with which the pin is locked in place.

9. A system according to claim 1 wherein a carrier device is provided for pivoting the flexoprinting cylinder around a vertical axis.

10. A system according to claim 1 wherein a washer is provided near said engagement device which is automatically loadable with the flexoprinting cylinder.

11. A system according to claim 10 wherein the washer has an automatic opening and closing cover.

12. A system according to claim 1 wherein said stop has a claw-like shape.

13. A system according to claim 1 wherein a storage for flexoprinting cylinders is near said engagement device and is designed as a flat rack.

14. A system according to claim 1 wherein a storage is provided near said engagement device for storing at least one of flexoprinting sleeves, spacing sleeves, or flexoprinting cylinders.

15. A system according to claim 14 wherein said storage comprises an adjustable storage.

16. A system according to claim 1 wherein a crane is provided for loading or unloading the flexoprinting cylinder from said engagement device and delivering it to or from a storage for flexoprinting cylinders.

17. A system according to claim 1 wherein a traveling crane transports flexoprinting cylinders to and from said engagement device and also transports spacers to and from a spacer storage near said engagement device.

18. A system according to claim 1 wherein a controller, job ticket station, and RIP station, are located near said engagement device, said line controller controlling operation of said engagement device and also controlling operation of a crane for loading and unloading flexoprinting cylinders at said engagement device and installing a spacer if needed on said flexoprinting cylinder.

19. A system according to claim 1 wherein a controller is provided controlling operation of a job ticket station and an RIP station along with controlling operation of said engagement device.

20. A system according to claim 1 wherein a crane is positioned to unload flexoprinting cylinders from said engagement device for delivery to an engraving machine near said engagement device.

21. A system to support a flexoprinting cylinder to permit placement thereon or removal therefrom of a flexoprinting sleeve or a spacer for the flexoprinting sleeve, and which permits rotation of said cylinder for processing of said flexoprinting form, comprising:
an engagement device with which the flexoprinting cylinder is automatically engaged for driving in a rotating manner for the processing of the flexoprinting form mounted on the flexoprinting cylinder;
the engagement device comprising respective cones inserted into respective end openings located in respective pins at opposing ends of the flexoprinting cylinder, and for at least one of the cones, a support device supporting the respective pin at one end of the flexoprinting cylinder during an insertion or retraction of the respective cone; and
the support device having a locking block which allows support of the flexoprinting cylinder in cantilever fashion to allow the sleeve or the spacer to be slipped over an unsupported opposite end of the flexoprinting cylinder, and also having a stop engageable at a recess in the pin and which can abut against a sidewall defined by a larger diameter portion of the pin.
